(19) United States
(12) Patent Application Publication
(10) Pub. No.: US 2016/0322999 A1
(43) Pub. Date: Nov. 3, 2016

(54) ELECTRONIC DEVICE INCLUDING ANTENNA

(71) Applicant: SAMSUNG ELECTRO-MECHANICS CO., LTD., Suwon-si (KR)

(72) Inventors: Doo Il KIM, Suwon-si (KR); Won Wook SO, Suwon-si (KR)

(73) Assignee: SAMSUNG ELECTRO-MECHANICS CO., LTD., Suwon-si (KR)

(21) Appl. No.: 15/090,946

(22) Filed: Apr. 5, 2016

(30) Foreign Application Priority Data
Apr. 29, 2015 (KR) 10-2015-0060591
May 8, 2015 (KR) 10-2015-0064864
Dec. 2, 2015 (KR) 10-2015-0170705

(51) Int. Cl. H04B 1/3827; H01Q 1/27

(52) U.S. Cl. CPC H04B 1/385; H01Q 1/273

(57) ABSTRACT

An electronic device includes a housing accommodating a communications circuit, a strap having one end connected to the housing and bent to couple another end of the strap and the housing, and an antenna included in at least one of the housing and the strap and connected to the communications circuit.

### CROSS-REFERENCE TO RELATED APPLICATION(S)

This application claims the benefit under 35 USC 119(a) of Korean Patent Application Nos. 10-2015-0060591 filed on Apr. 29, 2015, 10-2015-0064864 filed on May 8, 2015, and 10-2015-0170705 filed on Dec, 2, 2015 in the Korean Intellectual Property Office, the entire disclosure of which is incorporated herein by reference for all purposes.

### BACKGROUND

1. Field

The following description relates to an electronic device including an antenna.

2. Description of Related Art

In general, a strap has a band form having two ends connected to each other so as to be able to be worn on a body of a user, and may be used as a watch, a belt, a wearable band, and the like. Such a strap attaches an electronic device to a user, such as by affixing the device to an appendage.

Straps have recently been used as a component of a wearable electronic device such as a smart watch. Through such a wearable electronic device performing communications with an external electronic apparatus, a user may confirm information which operates the external electronic apparatus or is associated with the external electronic apparatus. For example, the wearable electronic device communicates with the external electronic apparatus to upload and download data to provide the wearable electronic device with enhanced communications functionality that allows the wearable electronic device access to data from sources such as the Internet, and allows information received at the wearable electronic device from sensor to be shared more effectively.

Therefore, a recent wearable electronic device requires an antenna for communications, such as with the external electronic device. Further, the recent wearable electronic devices are gradually being miniaturized due to factors such as an improvement in performance, a reduction in costs, convenience of the user, a design, and similar factors that increase the ability to provide and demand for smaller, more portable devices. However, since a typical size of the antenna is proportional to a wavelength of a signal transmitted and received by the antenna, it is difficult to miniaturize the antenna while maintaining signal wavelength.

Furthermore, if the wearable electronic device uses a plurality of communications signals to support various communications or secure the security of communications, the antenna is required to be designed while also considering interference aspects that may be caused between the plurality of communications signals. Therefore, the difficulty involved in constructing such an antenna in the wearable electronic device has gradually increased.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an electronic device includes a housing including a communications circuit, a strap having one end connected to the housing and bent to couple another end of the strap and the housing, and an antenna located in at least one of the housing and the strap and connected to the communications circuit.

The electronic device may further include a display panel located on the strap and configured to display time information.

The antenna may be an in-mold antenna.

The electronic device may further include a substrate connected to the antenna and may be configured to provide a space in which the communications circuit is to be located, and a battery, located on the substrate, configured to supply power to the communications circuit.

The electronic device may further include another antenna located on the substrate, wherein the communications circuit processes a first communications signal and a second communications signal, the antenna transmits and/or receives the first communications signal, and the other antenna transmits and/or receives the second communications signal.

One of the communications circuit, the other antenna, and the battery may be located on one surface of the substrate, and the others of the communications circuit, the other antenna, and the battery may be located on another surface of the substrate.

The antenna may include a conductor pattern, the other antenna may include a coil pattern, and a frequency of the first communications signal may be higher than a frequency of the second communications signal.

The first and/or second communications signals may be used to control a vehicle.

The housing may be formed of a non-metal material, and the strap may be formed of a urethane material.

In another general aspect, an electronic device includes a substrate on which a communications circuit is located, a strap bent to be worn on a body and comprising the substrate, a coupling part coupling one end of the strap and another end of the strap to each other, and an antenna located in at least one of the coupling part and the strap and connected to the communications circuit.

The electronic device may further include a display panel located on the strap and connected to the communications circuit, configured to display information.

The electronic device may further include a battery, located on the substrate, configured to supply power to the communications circuit.

The substrate may include a bending region and a non-bending region, the communications circuit may be located on the non-bending region, the battery may be located on the non-bending region, and the communications circuit and the battery may be separated from each other by the bending region.

The electronic device may further include another antenna disposed on the non-bending region, wherein the communications circuit processes a first communications signal and a second communications signal, the antenna transmits and/or receives the first communications signal, and the other antenna transmits and/or receives the second communications signal.

The antenna may include a conductor pattern, the other antenna may include a coil pattern, and a frequency of the first communications signal may be higher than a frequency of the second communications signal.

The communications circuit may process a communications signal.

The communications circuit may wirelessly receive power and the battery may be supplied with power by the communications circuit.

The first and/or second communications signals may be used to control a vehicle.

The communications circuit may generate and compress a digital signal, convert the digital signal into an analog signal, and transmit the analog signal to the antenna.

Other features and aspects will be apparent from the following detailed description, the drawings, and the claims.

### BRIEF DESCRIPTION OF THE DRAWINGS

FIG. 1A and FIG. 1B are conceptual diagrams illustrating an electronic device according to an embodiment.

FIG. 2 is a diagram illustrating a communications operation of the electronic device illustrated in the embodiment of FIG. 1.

FIG. 3 is a diagram illustrating an electronic device including an antenna according to an embodiment.

FIG. 4 is a diagram illustrating an electronic device including an antenna according to an embodiment.

FIG. 5A through 5C are diagrams illustrating the electronic device of the embodiment of FIG. 4 in further detail.

FIG. 6A though 6C are diagrams illustrating the electronic device of the embodiment of FIG. 3 in further detail.

FIG. 7A through 7C are diagrams illustrating an embedded form of the antenna in the electronic device of the embodiment of FIG. 3.

FIG. 8 is a side view of the electronic device of the embodiment of FIG. 4.

FIG. 9A through 9C are diagrams illustrating a strap of the electronic device of the embodiment of FIG. 3.

FIG. 10 is a diagram illustrating an electronic device including an antenna according to an embodiment.

FIG. 11 is a diagram illustrating an electronic device including an antenna according to an embodiment in further detail.

FIG. 12 is a diagram illustrating an electronic device including an antenna according to an embodiment in further detail.

FIG. 13 is a diagram illustrating the an electronic device including an antenna according to an embodiment in further detail.

FIG. 14 is a diagram illustrating a layout of the antenna of the embodiment of FIG. 10.

FIG. 15 is a diagram illustrating a layout of the antenna of the embodiment of FIG. 10.

FIG. 16 is a diagram illustrating a layout of the antenna of the embodiment of FIG. 10.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. The sequences of operations described herein are merely examples, and are not limited to those set forth herein, but may be changed as will be apparent to one of ordinary skill in the art, with the exception of operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

Throughout the specification, it is to be understood that when an element, such as a layer, region or wafer, such as a substrate, is referred to as being “on,” “connected to,” or “coupled to” another element, it may be directly “on,” “connected to,” or “coupled to” the other element or other elements intervening between the element and the other element may be present. In contrast, when an element is referred to as being “directly on,” “directly connected to,” or “directly coupled to” another element, there are intended to be no elements or layers intervening between the element and the other element. Like numerals refer to like elements throughout. As used herein, the term “and/or” includes any and all combinations of one or more of the associated listed items.

It is to be apparent that though the terms first, second, third, and so on are used herein to describe various members, components, regions, layers and/or sections, these members, components, regions, layers and/or sections are not to be limited by these terms. These terms are only used to distinguish one member, component, region, layer or section from another region, layer or section. Thus, a first member, component, region, layer or section discussed below could also be termed a second member, component, region, layer or section without departing from the teachings of the embodiments.

Spatially relative terms, such as “above,” “upper,” “below,” and “lower” and the like, are used herein for ease of description to describe one element's relationship to another element(s) as shown in the figures. It is to be understood that the spatially relative terms are intended to encompass different orientations of the device in use or operation in addition to the orientation depicted in the figures. For example, if the device in the figures is turned over, elements described as “above,” or “upper” other elements would then be oriented “below,” or “lower” the other elements or features. Thus, the term “above” encompasses both the above and below orientations depending on a particular direction or alignment of the figures. Also, the device is possibly otherwise oriented, such as by being rotated 90 degrees or positioned at other orientations and the spatially relative descriptors used herein are to be interpreted accordingly.

The terminology used herein is for describing particular embodiments only and is not intended to be limiting. As used herein, the singular forms “a,” “an,” and “the” are intended to include the plural forms as well, unless the context clearly indicates otherwise. It is to be further understood that the terms “comprises,” and/or “comprising” when used in this specification, specify the presence of stated features, integers, steps, operations, members, elements, and/or groups thereof, but do not preclude the presence or addition of one or more other features, integers, steps, operations, members, elements, and/or groups thereof.

Subsequently, embodiments are described with reference to schematic views illustrating such embodiments. In the drawings, for example, due to manufacturing techniques and/or tolerances, modifications of the shape shown are estimated, and embodiments may diverge somewhat from what is depicted in the drawings. Thus, embodiments are not to be construed as being limited to the particular shapes of regions shown in the drawings, and may, for example, include a change in shape resulting from manufacturing factors. The following embodiments also possibly constituted by one or a combination thereof the features depicted in the drawings.

For example, the contents of the present embodiments described below may have a variety of configurations and propose only required configurations in the following description, but are not limited thereto and may possibly include appropriate additions and variations.

Thus, an aspect of the present disclosure provides an electronic device including an antenna.

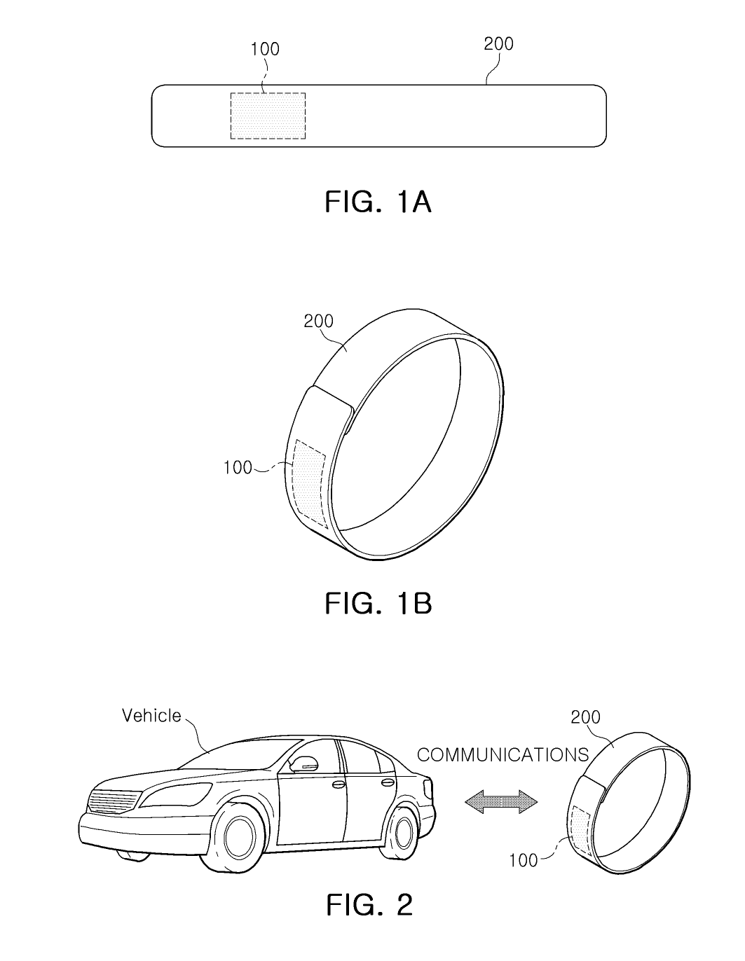

FIG. 1A and FIG. 1B are conceptual diagrams illustrating an electronic device according to an embodiment.

Referring to the embodiment of FIG. 1A, an antenna 100 is embedded in a strap 200. For example, the antenna 100 is embedded as an in-mold antenna (IMA) so as not to be exposed to a surface of the strap 200. Therefore, in an embodiment, the antenna 100 is manufactured together with the strap 200 by injection molding. However, other appropriate approaches to embedding the antenna 100 in the strap 200 are used, as appropriate, in other embodiments.

Referring to the embodiment of FIG. 1B, one end of the strap 200 in which the antenna 100 is embedded and the other end of the strap 200 are connected to each other. Accordingly, the strap 200 forms a ring structure, allowing the strap 200 to surround a portion of a user's body to attach the strap 200 to the user. To this end, the strap 200 is required to be bent. As the strap 200 is bent, directions of force applied to the center and an end of the embedded antenna 100 are possibly opposite to each other. As a result, these forces possibly modify a form of the embedded antenna 100. In an example in which the strap 200 is formed of a material having excellent flexibility such as a plastic material, such as a urethane material, the embedded antenna 100 is able to maintain an original form despite the force on the strap 200.

Thus, in such an example, the strap 200 is a band having one end and another end that are connected to each other so as to be able to be worn on a human body. Accordingly, such strap 200 may be used for a watch, a belt, a wearable band, a headband, a necklace, and so on.

FIG. 2 is a diagram illustrating a communications operation of the electronic device illustrated in the embodiment of FIG. 1.

Referring to the example of FIG. 2, the antenna 100 embedded in the strap 200 transmits and receives a signal to and from a smart key that performs wireless communications with a vehicle.

In an embodiment, the antenna 100 transmits and receives a high frequency signal for long distance communications with the vehicle, and transmits and receives a low frequency signal for short distance communications with the vehicle. In general, the use of different frequencies is appropriate because use of different frequencies allows good power efficiency while ensuring successful communications at a given distance.

For example, the antenna 100 includes an antenna for transmitting the high frequency signal and an antenna for transmitting the low frequency signal. That is, in an embodiment, the antenna 100 includes a plurality of antennas. In such an embodiment, at least one antenna 100 is embedded in the strap 200.

For example, the high frequency signal is a signal that recognizes state information of the vehicle, a user location, and so on, to prepare for a specific operation. For example, the high frequency signal may have a frequency band of about 315 MHz/434 MHz. However, other frequency bands are possible for the high frequency signal, used as appropriate in other embodiments.

In such an example, the high frequency signal has a communications range longer than that of the low frequency signal. Therefore, the high frequency signal is used for communications for which security is relatively less important and in which a longer communications range is required.

In an example, the low frequency signal may be a signal for controlling ignition of the vehicle, and other similar uses. In such uses, authentication is potentially appropriate. For example, the low frequency signal has a frequency band of about 125 KHz. However, other frequency bands are possible for the low frequency signal, used as appropriate in other embodiments.

In such an example, the low frequency signal has a communications range shorter than that of the high frequency signal. Therefore, the low frequency signal is used for communications in which high security is required.

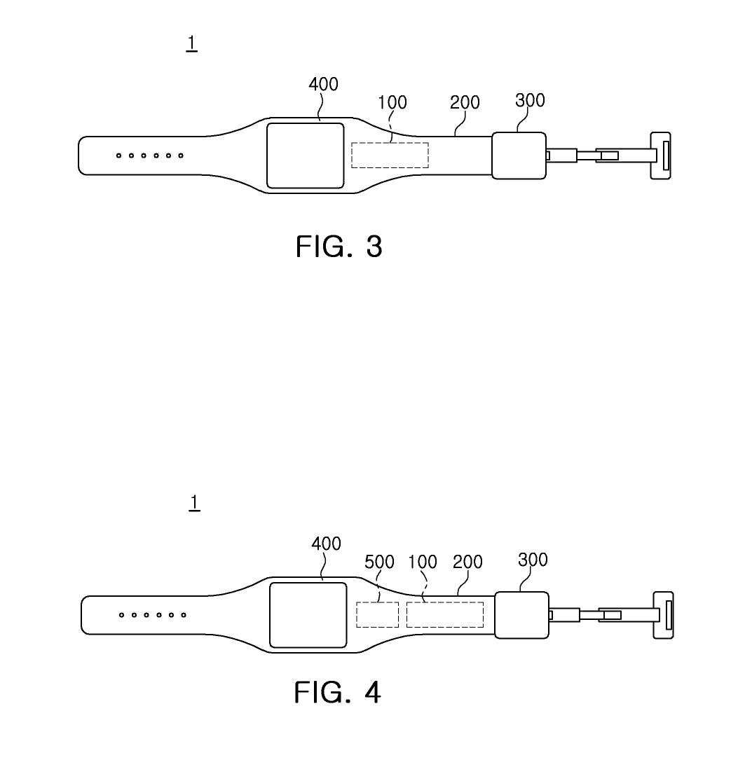

FIG. 3 is a diagram illustrating an electronic device including an antenna according to an embodiment.

Referring to the embodiment of FIG. 3, the electronic device 1 includes an antenna 100, a strap 200, a housing 300, and a display panel 400.

For example, the electronic device 1 is a smart watch or a wearable accessory. Depending on a design, the electronic device 1 optionally further includes an electronic module and/or a camera that senses information related to the human body, such as the body of a user that wears the electronic device 1. For example, the electronic device 1 is worn on one of the wrists of the user, but the electronic device 1 may be worn around another appendage of the user, such as being a headband, a necklace, or an ankle bracelet.

For example, the antenna 100 is disposed to be adjacent to the display panel 400 in the strap 200. Due to mechanism characteristics of a smart watch, a portion of such a smart watch that is adjacent to the display panel 400 in the strap 200 is relatively less bent than portions that are not adjacent to the display panel 400. Therefore, the antenna 100 being located in the portion of the strap 200 that is adjacent to the display panel 400 is able to maintain an original form for a relatively long time as the antenna 100 is subjected to less force as a result of the bending.

In addition, for the antenna 100 located in the portion that is adjacent to the display panel 400 in the strap 200, a design prepared to reducing bending is provided. Therefore, the strap 200 in which the antenna 100 is embedded may have a reduced thickness, which helps reduce bending.

In this embodiment, the housing 300 is fixed on the strap 200 and fastens one end of the strap 200 and the other end of the strap 200 to each other, causing the strap to form a ring structure. For example, the housing 300 is a buckle formed of a plastic or metal material. However, other options are available for the housing 300, such as a snap or another appropriate type of fastener.

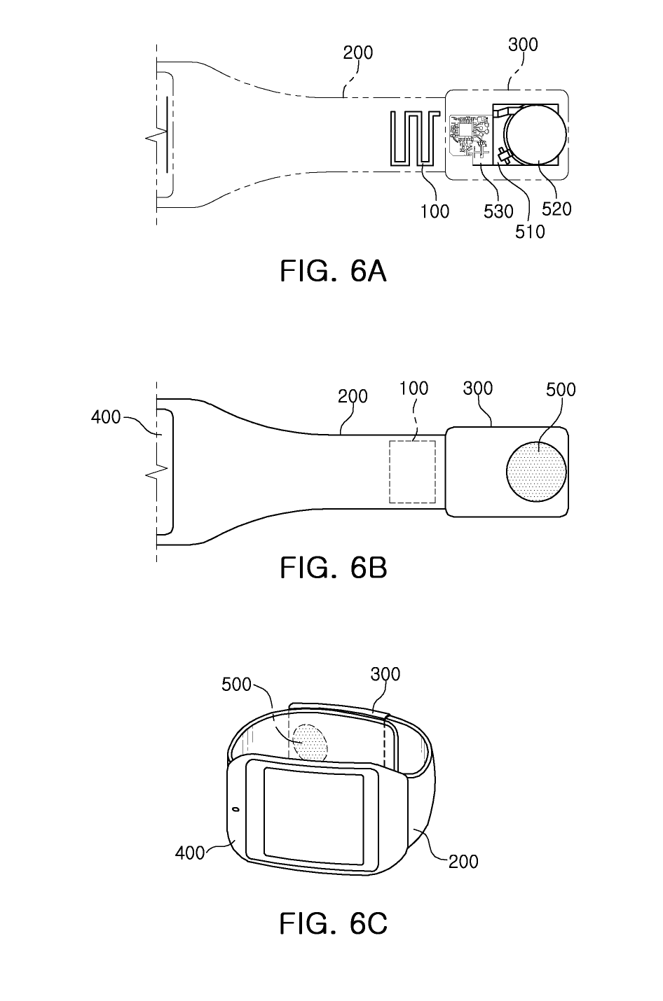

In one embodiment, the housing 300 is separated from the strap 200. An additional detail of the housing 300 according to such an embodiment is described below with reference to FIGS. 6A through 6C.

The display panel 400 performs a generation operation, a processing operation, and other similar operations of a signal for a remote control by the user and an information provider for the user. For example, the display panel 400 is a watch that provides a time indicator or a smart key module in the smart watch used for validation and security functions. Meanwhile, depending on a design, the display panel 400 also simultaneously performs a smart watch function and a smart key function, so as to provide both of these functions.

In addition, in an embodiment, the strap 200 is connected through one side of the display panel 400 and the other side of the display panel 400. In such an embodiment, due to display function characteristics of the display panel 400, a width of a region that is closer to the display panel 400 of the strap 200 is wider than that of a region which is distant from the display panel 400 of the strap 200. Therefore, the antenna 100 is more easily embedded in the region that is closer to the display panel 400 in the strap 200.

In an example, a width of the housing 300 is about 26.5 mm, a width of the display panel 400 is about 37.34 mm, and the housing 300 and the display panel 400 are spaced apart from each other by about 76 mm. A thickness of the housing 300 is about 3.24 mm, and a thickness of the strap 200 is between about 1.8 mm and 2 mm.

FIG. 4 is a diagram illustrating an electronic device including an antenna according to an embodiment.

Referring to the embodiment of FIG. 4, the electronic device 1 includes the antenna 100, the strap 200, the housing 300, the display panel 400, and a communications module 500.

For example, the communications module 500 is embedded in the strap 200 to help perform a generation operation, a processing operation, and other similar operations of a signal for a remote control by the user and an information provider for the user. For example, the communications module 500 is embedded in the strap 200 to perform the smart key function. In such an example, the display panel 400 performs the smart watch function.

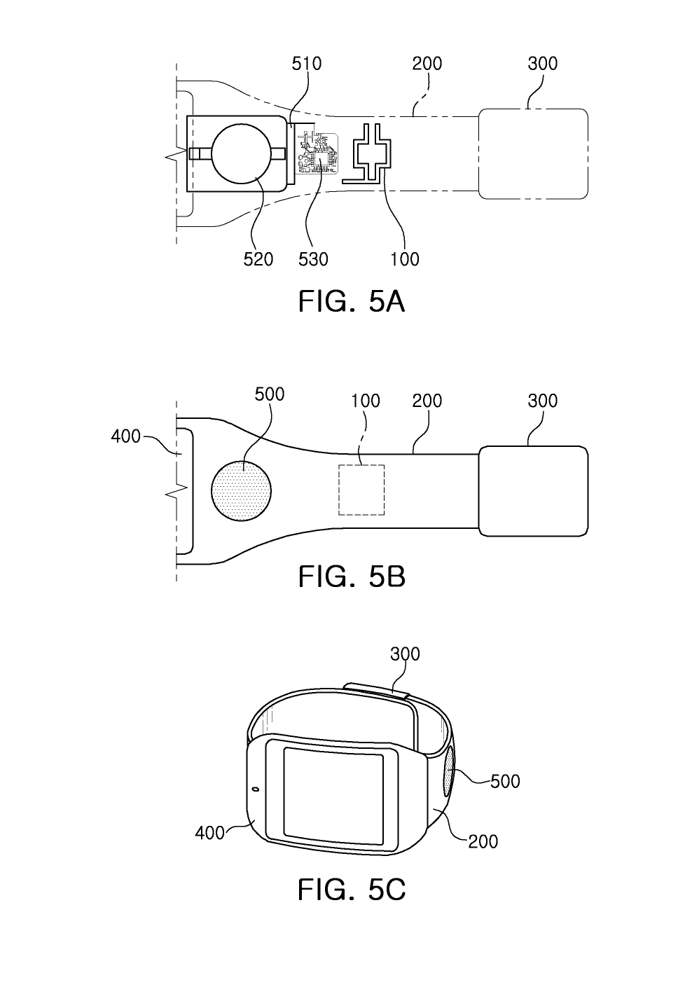

In an example, the communications module 500 is embedded in the housing 300. A more detailed configuration and a more detailed layout position of the communications module 500 is described further below with reference to FIGS. 5A through 6C and FIGS. 11 through 13.

Meanwhile, depending on a design of the electronic device 1, the antenna 100 transmits and receives at least one of a signal for the display panel 400 and a signal for the communications module 500. Therefore, the antenna 100 is electrically connected to at least one of the display panel 400 and the communications module 500.

FIG. 5A, FIG. 5B, and FIG. 5C are diagrams illustrating the electronic device of the embodiment of FIG. 4 in further detail.

FIG. 5A illustrates an interior of the electronic device of the embodiment of FIG. 4, FIG. 5B illustrates an exterior of the electronic device of the embodiment of FIG. 4, and FIG. 5C illustrates an example in which one end of the strap 200 and the other end of the strap 200 are fastened to each other by the housing 300.

Referring to the example of FIG. 5A, the communications module 500 includes a substrate 510, a battery 520, and a communications circuit 530.

In the example of FIG. 5A, a plurality of circuits that process a signal or supply power are located on the substrate 510. For example, the substrate 510 is one of a ceramic substrate, a flexible substrate, a printed circuit board (PCB), a flexible printed circuit board (FPCB), and a rigid PCB, or a combination of two or more of these options. However, these are only examples and other embodiments use an alternative way of providing the substrate 510. In such an example, the substrate 510 is smoothed and/or miniaturized. For example, in an example in which the battery 520 and the communications circuit 530 are located on the substrate 510, the substrate 510 between the battery 520 and the communications circuit 530 is possibly bent. As discussed above, such bending is due to the bending of the strap 200 upon which the communications module is mounted. For example, the bending of the substrate 510 is implemented by using a flexible PCB, or another type of substrate that is able to accommodate a certain amount of bending.

In this example, the battery 520 supplies power to the communications circuit 530. For example, the battery 520 is located on the substrate 510 in a button cell form or is connected to the substrate 510 to be in a linear form. However, these are merely examples and other battery 520 positions and forms are used in other examples.

The communications circuit 530 generates and processes a communications signal. For example, the communications circuit 530 generates and processes both of a signal of a low frequency band and a signal of a high frequency band, respectively, and outputs the signal of a low frequency band and the signal of a high frequency band to the antenna 100.

Also, the communications circuit 530 may include an antenna that transmits and receives just one of the signal of a low frequency band and the signal of a high frequency band. For example, the communications circuit 530 includes a separate low frequency antenna that transmits and receives just the low frequency signal, in order to transmit and receive the low frequency signal, and the high frequency signal is transmitted and received separately by the antenna 100. It will also be recognized that it is possible to have a separate high frequency antenna, such that the high frequency signal is transmitted and received separately by the high frequency signal antenna and the antenna 100 transmits and receives the low frequency antenna, or both high frequency and low frequency signals are transmitted and received by specialized, separate antennas.

Accordingly, interference between the low frequency antenna and a high frequency antennas is possibly reduced by managing transmission in this manner.

If the low frequency antenna and the high frequency antenna are incorporated into the communications circuit 530, a size of the communications module 500 is possibly increased depending on whether a design that considers interference between the low frequency antenna and the high frequency antenna is used to implement the antenna or antennas. Accordingly, the communications module 500 is possibly not embedded into the strap 200 or possibly adversely affects the electronic device from a design viewpoint.

However, in the electronic device according to an embodiment, the antenna 100 is embedded in the strap 200, and accordingly interference between a plurality of antennas is reduced. Accordingly, a degree of freedom of a layout of the plurality of antennas is also increased. Accordingly, performance of the electronic device is improved, a thickness of the electronic device may be reduced, an area of the electronic device may be reduced, and a degree of freedom of a design of the electronic device may be improved.

Referring to the examples of FIG. 5B and FIG. 5C, the electronic device according to an embodiment performs a plurality of electronic functions that differ from each other by using the display panel 400 and the communications module 500, and transmits and receives the signal through the antenna 100. For example, the antenna 100 is embedded as an in-mold antenna (IMA) so as not to be exposed to a surface of the strap 200. Such avoidance of exposure improves the functioning of the antenna 100.

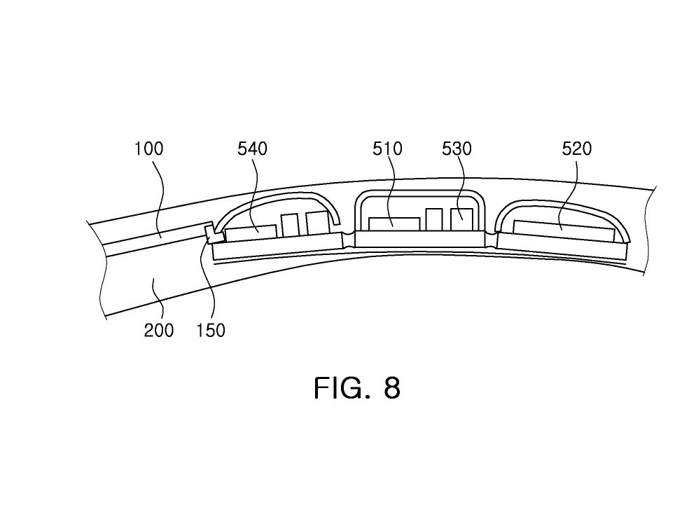

Also, the antenna 100 is connected to the display panel 400 and/or the communications module 500 such as through a switch and/or a connector. A further detailed description of these elements is provided below with reference to FIG. 8.

FIG. 6A, FIG. 6B, and FIG. 6C are diagrams illustrating the electronic device of the embodiment of FIG. 3 in further detail.

According to the embodiment of FIG. 3, FIG. 6A illustrates an interior of the electronic device, FIG. 6B illustrates an exterior of the electronic device, and FIG. 6C illustrates a form in which one end of the strap 200 and the other end thereof are fastened to each other by the housing 300.

Referring to the example of FIG. 6A, the communications module 500 includes the substrate 510, the battery 520, and the communications circuit 530, and is embedded in the housing 300. That is, the substrate 510 upon which the battery 520 and the communications circuit 530 are located is embedded in the housing 300.

For example, the battery 520 and the communications circuit 530 are located on opposite surfaces of the substrate 510. Also, in an example, the housing 300 has a thickness greater than that of the strap 200. Therefore, the substrate 510, such that the battery 520 and/or the communications circuit 530 are located on opposite surfaces of the substrate, is embedded in the housing 300.

However, since the housing 300 may include a metal material as a constituent material, it may be difficult to embed the antenna in the housing 300. Therefore, the antenna 100 is separated from the battery 520 and/or the communications circuit 530 when the antenna 100 is embedded into the strap 200. Accordingly, a material of the housing is then more freely selected when the housing is designed in such a manner, and a size of the housing 300 is also further reduced. Accordingly, in the electronic device according to an embodiment, a degree of freedom of a design is improved.

Furthermore, in an example, the housing 300 is also separated from the strap 200. That is, a second electronic module, for example, the communications module 500, is separated from the antenna 100 and the display panel 400. Accordingly, in the electronic device according to such an embodiment, a plurality of electronic modules that perform different electronic functions are separated from each other, and user convenience and performance are accordingly improved.

For example, the user is able to separate the communications module 500 from the electronic device as a whole in order to repair or rent the communications module 500 individually. In this case, the user may continue to use other electronic modules, such as the display panel 400, as so on, included in the electronic device.

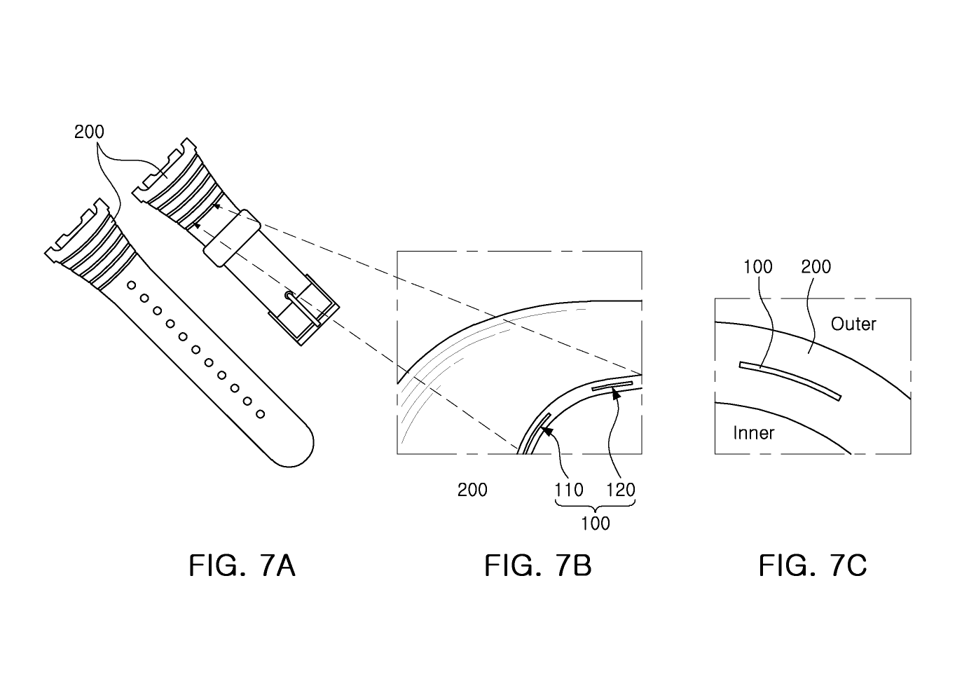

FIG. 7A, FIG. 7B, and FIG. 7C are diagrams illustrating an embedded form of the antenna in the electronic device of the embodiment of FIG. 3.

FIG. 7A illustrates a top surface of the strap 200, FIG. 7B illustrates a top side surface of the strap 200, and FIG. 7C illustrates a side surface of the strap 200.

For example, the antenna 100 includes first and second antenna patterns 110 and 120. That is, in an example, when the antenna 100 is viewed from a side surface, the antenna 100 has a form in which the first antenna pattern 110 and the second antenna pattern 120 are electrically connected to each other. For example, the first antenna pattern 110 and the second antenna pattern 120 each have a form of [L]. Here, the form of [L] refers to a structure in which a long rod and a short rod are connected to each other. Here, a coupled form of the first antenna pattern 110 and the second antenna pattern 120 is a form in which they are connected to each other in this order of the long rod, the short rod, the long rod, and the short rod. Accordingly, a durability of the antenna 100 as a whole is improved.

Referring to FIG. 7C, an antenna 100 is embedded in the strap 200, having a thickness of about 1.1 mm. As the strap 200 is bent, directions of force applied to the center and an end of the antenna 100 are opposite to each other.

In an embodiment, as flexibility of a material of the strap 200 is increased, the force applied to the antenna 100 is decreased. Therefore, the strap 200 is implemented using a material having high flexibility. For example, the strap 200 is implemented using urethane, leather, vinyl, other flexible plastics, and similar materials.

FIG. 8 is a side view of the electronic device of the embodiment of FIG. 4.

Referring to the example of FIG. 8, the antenna 100 is electrically connected to the substrate 510 through a connection part 150, and another antenna, or a second antenna, 540 is located on the substrate 510.

That is, the antenna 100 and the second antenna 540 are implemented using different methods. Antennas from a plurality of antennas implemented by the differing methods are included in the electronic device, and accordingly interference between the plurality of antennas is reduced.

For example, the antenna 100 transmits and receives the high frequency signal and the second antenna 540 transmits and receives the low frequency signal.

In such an example, the connection part 150 is a connector. In an example in which it is assumed that an internal antenna 130, the connection part 150, and the substrate 510 are integrated together, the connection part 150 serves as a joint.

In addition, referring to the embodiment of FIG. 8, the strap 200 accommodates the second antenna 540, the battery 520, and a chip set 530 by a using a membrane formed of a soft urethane material. However, this is only an example material and other materials are used for the membrane, as appropriate, in other embodiments. Accordingly, the second antenna 540, the battery 520, and the chip set 530 are protected from force and impact applied to these elements as the strap 200 is bent.

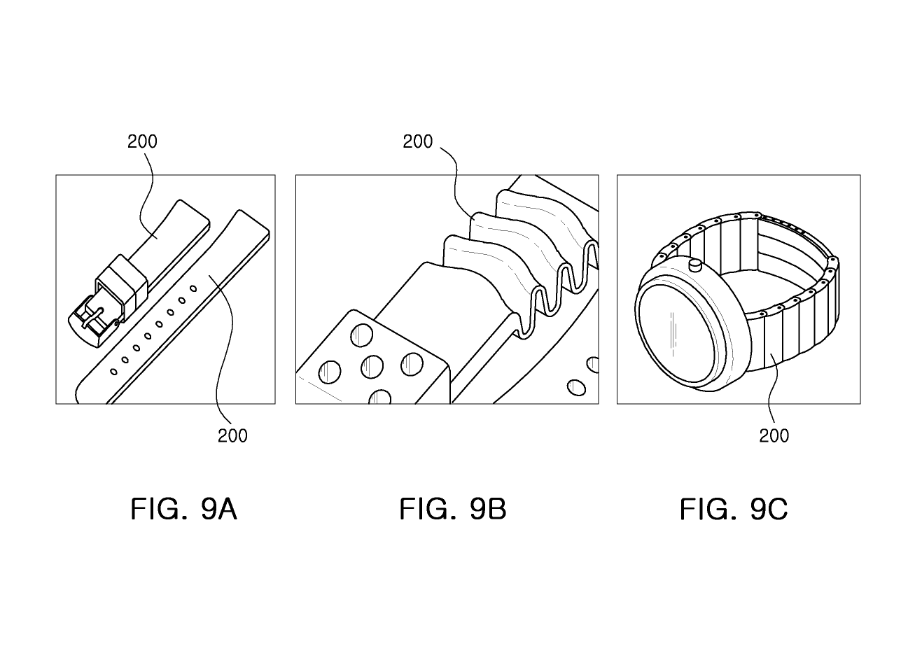

FIG. 9A, FIG. 9B, and FIG. 9C are diagrams illustrating the strap of the electronic device of the embodiment of FIG. 3.

Referring to the example of FIG. 9A, the strap 200 may have a flat form.

Referring to the example of FIG. 9B, the strap 200 may have a corrugated form. For example, the antenna has a form in which it is folded along a curved surface of the strap 200.

Referring to the example FIG. 9C, the strap 200 may have a chain form. For example, the antenna has a form in which it is folded along a chain of the strap 200.

The form of the strap 200 is not intended to be limited to the forms illustrated in FIGS. 9A-9C. That is, the strap 200 is implemented in various forms in various embodiments as long as the antenna is embedded using an in-mold antenna (IMA) technology in strap 200.

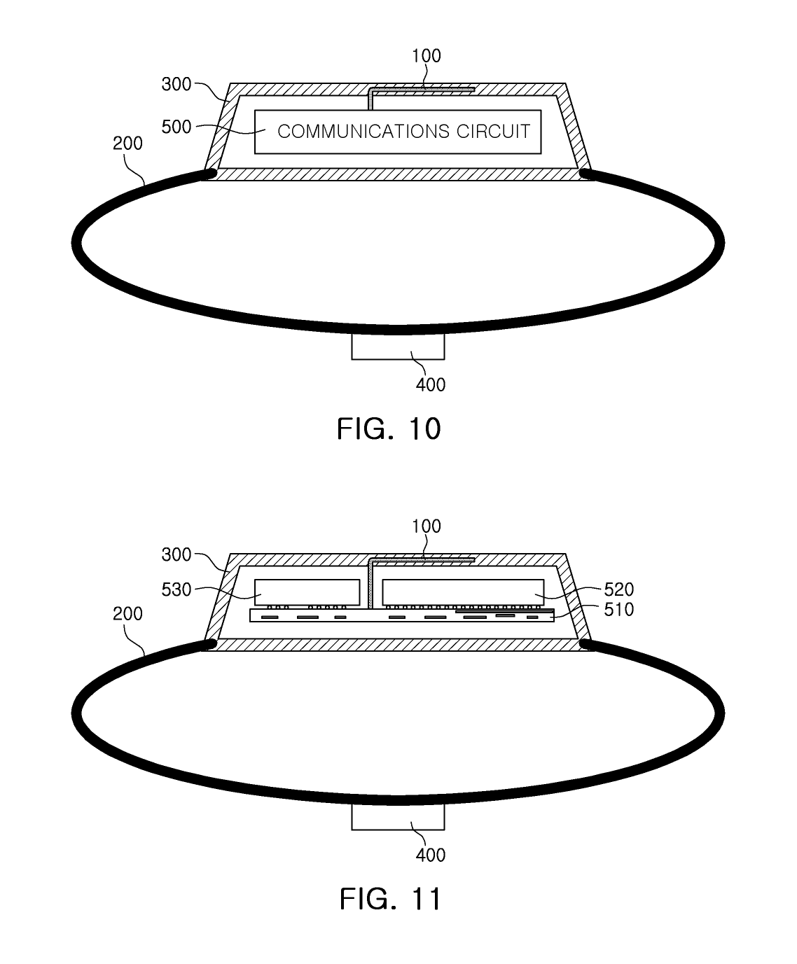

FIG. 10 is a diagram illustrating an electronic device including an antenna according to an embodiment.

Referring to the embodiment of FIG. 10, the electronic device according to an embodiment includes the antenna 100, the strap 200, the housing 300, the display panel 400, and the communications circuit 530.

In the embodiment of FIG. 10, the antenna 100 is embedded in the housing 300 and is electrically connected to the communications circuit 530 to transmit and receive the communications signal. That is, the antenna 100 is embedded in the housing 300 as well as the strap 200.

In this embodiment, the strap 200 is bent so as to be worn on the human body. For example one end of the strap 200 is connected to the housing 300, and the other end of the strap 200 is detached from the housing 300. Subsequently, the ends of the strap 200 are attached together by the housing 300 For example, in a case in which the strap 200 is worn on the human body, both ends of the strap 200 are coupled to each other, and thus the strap 200 is affixed to the human body, by surrounding a portion of the human body.

In the embodiment of FIG. 10, the housing 300 accommodates the communications circuit 530 that processes the communications signal. For example, the housing 300 is formed of a non-metal material such as plastic in order to smoothly perform communications by avoiding possible effects on the communications that would result from using a metal housing 300.

In this embodiment, the housing 300 couples both ends of the strap 200 to each other, embeds the antenna 100 in the housing 300, and accommodates the communications circuit 530 in a space surrounded by the housing 300. As such, the electronic device according to an embodiment efficiently uses the space around the housing 300 without detrimental performance effects. Accordingly, a layout space of the antenna 100 is secured and a size of the electronic device is also reduced.

For example, the display panel 400 is included in the strap 200 to display time information. In an example, example, the display panel 400 acts as a watch of the smart watch. That is, the display panel displays information about time. In the example in which the display panel 400 acts as the watch, the display panel 400 and the housing 300 are located so as to be opposite to each other when the strap 200 is worn on the human body. That is, the housing 300 acts as the buckle of the smart watch.

FIG. 11 is a diagram illustrating the communications module in further detail.

Referring to the example of FIG. 11, the communications module 500 includes the substrate 510, the battery 520, and the communications circuit 530.

In this example, the battery 520 and the communications circuit 530 are each disposed on the substrate 510. In addition, the substrate 510 is electrically connected to the antenna 100. For example, instead of locating the entirety of the antenna 100 on the substrate 510 in a pattern form, an electrical connector such as a wiring is provided. Accordingly, since the substrate 510 is not required to provide the layout space of the antenna 100, the entire size of the electronic device is possibly reduced. Therefore, since the electronic device according to an embodiment reduces a required accommodation space of the housing 300, and accordingly the costs and the size of the electronic device are also reduced.

In this example, the battery 520 supplies power to the communications circuit 530. In an example in which the antenna 100 wirelessly receives power, the battery 520 is supplied with power by the communications circuit 530.

In such an example, the communications circuit 530 processes the communications signal. For example, the communications circuit 530 generates and compresses a digital signal, converts the digital signal into an analog signal, and performs amplification, filtration, and frequency synthesis for the analog signal, accordingly transmitting the amplified, filtered, and frequency synthesized signal to the antenna 100. Further, the communications circuit 530 also processes the communications signal in the opposite order of the abovementioned order, such as to perform a reversed operation.

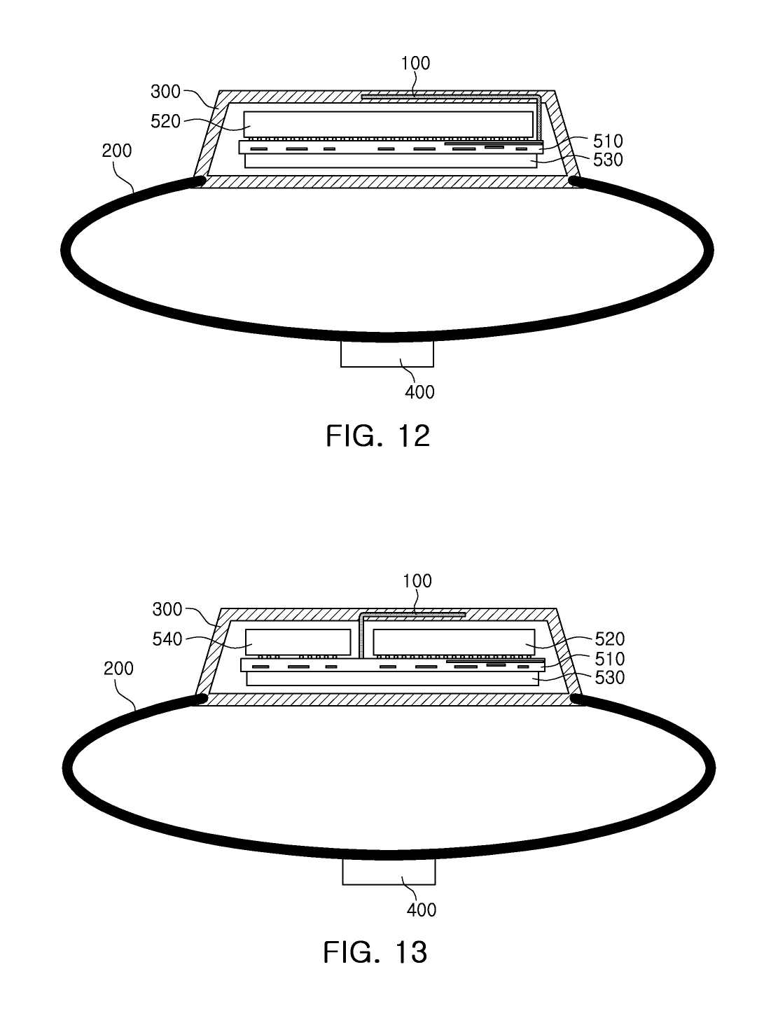

FIG. 12 is a diagram illustrating the communications module in further detail.

Referring to the example of FIG. 12, the substrate 510 includes the battery 520 and the communications circuit 530, each disposed on opposite surfaces of the substrate 510.

By comparison to the communications module of FIG. 11, a communications module of FIG. 12 has a greater thickness and a smaller area. Accordingly, the communications module is accommodated in the housing 300, where such a housing has a large thickness and a small area.

Further, in an example in which a thickness of the battery 520 is different from a thickness of the communications circuit 530, the communications module of FIG. 12 is more efficiently compressed in the housing 300 as compared to the communications module of the example of FIG. 11.

Meanwhile, in an example, the antenna 100 is connected to be adjacent to an edge of the substrate 510.

FIG. 13 is a diagram illustrating the communications module in further detail.

Referring to the example of FIG. 13, the communications module further includes the second antenna 540 as well as the substrate 510, the battery 520, and the communications circuit 530.

In the example of FIG. 13, the second antenna 540 is located on the substrate 510. For example, the second antenna 540 includes a plurality of coils that form radiation patterns in directions of an x axis, a y axis, and a z axis, respectively. Since an antenna having a coil form potentially forms the radiation pattern in one direction, the radiation patterns are accordingly formed in the directions of the x axis, the y axis, and the z axis.

That is, in an embodiment, as discussed further, above, the antenna 100 and the second antenna 540 are implemented by different methods. Antennas of a plurality of antennas, implemented according to the different methods, are included in the electronic device. As a result, interference between the plurality of antennas is reduced.

For example, the antenna 100 transmits and receives a high frequency signal of a band of 315/434 MHz. Therefore, the antenna 100 is implemented as the antenna having the pattern form, unlike the second antenna 540.

For example, the second antenna 540 transmits and receives a low frequency signal of a band of 125 KHz. Therefore, the second antenna 540 is implemented as the antenna having the coil form, unlike the antenna 100.

In a case in which the antenna 100 is located adjacent to the second antenna 540, there is a possible occurrence of an issue of radiation-related characteristics degradation. Therefore, the antenna 100 and the second antenna 540 may possibly be required to be spaced apart from each other.

For example, the antenna 100 is inserted into a plastic case in the pattern form so as to be spaced as far away as possible from the second antenna 540. As an example, an in-mold antenna (IMA) technology is utilized to provide such separation. Therefore, in an example, the antenna 100 is manufactured together with the housing 300 using an injection molding technique to provide the separation.

Accordingly, in an embodiment, the problem of the radiation-related characteristics degradation between the antenna 100 and the second antenna 540 is reduced. Accordingly, the electronic device according to an embodiment is compressed and located in the accommodation space of the housing, and accordingly significantly decreases an interference phenomenon between the plurality of antennas.

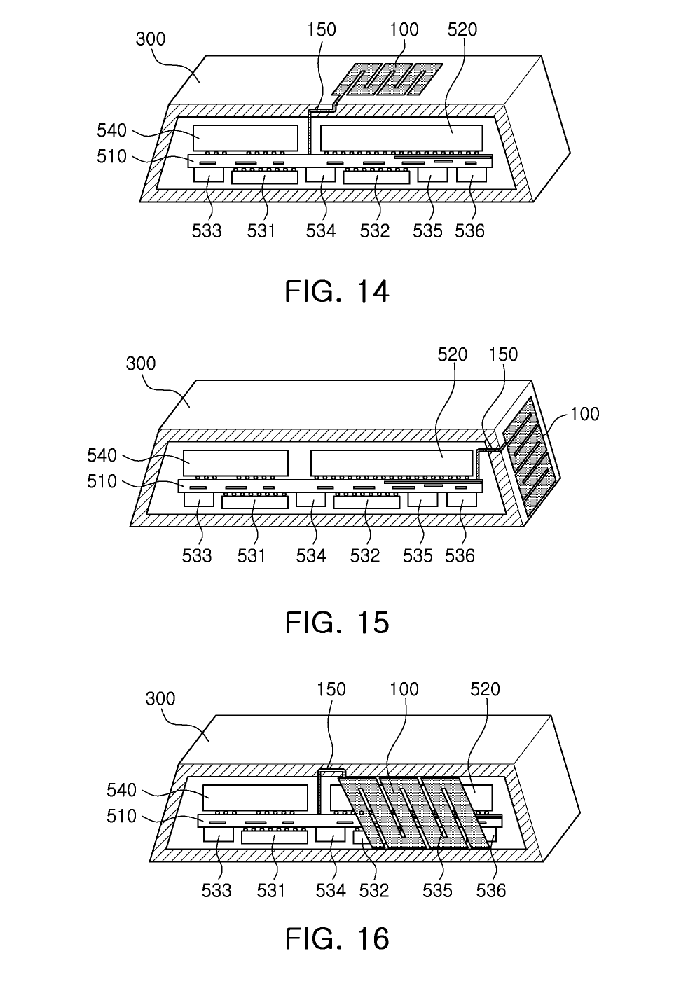

FIG. 14 is a diagram illustrating the layout of the antenna of the embodiment of FIG. 10.

Referring to the example of FIG. 14, an antenna 100 is embedded in a top surface of the housing 300. Accordingly, the radiation pattern is formed on the top surface of the housing 300.

Further, in such an example the communications circuit includes a first chip set 531 that processes the high frequency signal, a second chip set 532 that processes the low frequency signal, and a plurality of passive elements 533, 534, 535, and 536.

Meanwhile, as an example, a side surface of the housing 300 is used as a replacement passage of the battery 520. In general, a life span of the battery 520 is shorter than the life span of the first and second chip sets 531 and 532, and the life span of the plurality of passive elements 533, 534, 535, and 536. Therefore, in an example in which the battery 520 is frequently replaced, the entire lifespan of the electronic device according to an embodiment is increased, because an embodiment facilitates replacing the battery 520 easily without interfering with the other elements discussed above.

FIG. 15 is a diagram illustrating the layout of the antenna of the embodiment of FIG. 10.

Referring to the example of FIG. 15, the antenna 100 is embedded in one side surface of the housing 300. Accordingly, the radiation pattern is formed on such a side surface of the housing 300.

As an example, the top surface of the housing 300 is used to facilitate the replacement passage of the battery 520, by facilitating access to the battery 520 for easier replacement.

FIG. 16 is a diagram illustrating the layout of the antenna of the embodiment of FIG. 10.

Referring to the example of FIG. 16, the antenna 100 is embedded in a side surface perpendicular to one side surface of the housing 300. Accordingly, the radiation pattern is formed on the side surface, perpendicular to one side surface of the housing 300.

Referring to the examples of FIG. 14, FIG. 15, and FIG. 16, the antenna 100 is located at a position capable of significantly reducing interference with the low frequency antenna, such as a position chosen from among the top surface of the housing 300, a first side surface of the housing 300, and another side surface perpendicular to the first side surface of the housing 300.

Further, in an example, the antenna 100 is disposed on all of the top surface of the housing 300, a first side surface of the housing 300, and another side surface perpendicular to the first side surface of the housing 300. In such an example, multi-input multi-output (MIMO) technology is applied to the antenna 100. Accordingly, the antenna 100 also forms long radiation patterns in three directions.

Meanwhile, the layout position of the antenna 100 is also determined depending on a connection form of the strap 200 and a structure of the housing 300. For example, in an example in which the housing 300 is connected to the strap 200 using a form in which it is located on top of the strap 200, the antenna 100 is readily located on the side surfaces of the housing 300. Also, for example, in a case in which the side surface of the housing 300 is connected to a side surface of the strap 200, the antenna 100 is readily located on the top surface of the housing 300.

As set forth above, according to the embodiments, in the electronic device including the antenna, the layout space of the antenna is controlled and used efficiently, so accordingly the overall size of electronic device is reduced.

Further, in the electronic device including the antenna according to an embodiment, the antenna is disposed so that mutual interference between the plurality of antennas is reduced and communications are not limited or interfered with by the human body.

Further, in the electronic device including the antenna according to an embodiment, the antenna is located so that the antenna is not externally exposed and is not influenced by external factors, so accordingly the electronic device including the antenna is improved with respect to durability and reliability.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An electronic device comprising:
a housing comprising a communications circuit;
a strap having one end connected to the housing and bent to couple another end of the strap and the housing; and
an antenna located in at least one of the housing and the strap and connected to the communications circuit.

2. The electronic device of claim 1, further comprising: a display panel located on the strap and configured to display time information.

3. The electronic device of claim 1, wherein the antenna is an in-mold antenna.

4. The electronic device of claim 1, further comprising:
a substrate connected to the antenna and configured to provide a space in which the communications circuit is to be located; and
a battery, located on the substrate, configured to supply power to the communications circuit.

5. The electronic device of claim 4, further comprising: another antenna located on the substrate,
wherein the communications circuit processes a first communications signal and a second communications signal,
the antenna transmits and/or receives the first communications signal, and
the other antenna transmits and/or receives the second communications signal.

6. The electronic device of claim 5, wherein one of the communications circuit, the other antenna, and the battery is located on one surface of the substrate, and
the others of the communications circuit, the other antenna, and the battery are located on another surface of the substrate.

7. The electronic device of claim 5, wherein the antenna comprises a conductor pattern,
the other antenna comprises a coil pattern, and
a frequency of the first communications signal is higher than a frequency of the second communications signal.

8. The electronic device of claim 7, wherein the first and/or second communications signals are used to control a vehicle.

9. The electronic device of claim 1, wherein the housing is formed of a non-metal material, and
the strap is formed of a urethane material.

10. An electronic device, comprising:
a substrate on which a communications circuit is located;
a strap bent to be worn on a body and comprising the substrate;
a coupling part coupling one end of the strap and another end of the strap to each other; and
an antenna located in at least one of the coupling part and the strap and connected to the communications circuit.

11. The electronic device of claim 10, further comprising:
a display panel located on the strap and connected to the communications circuit, configured to display information.

12. The electronic device of claim 10, further comprising:
a battery, located on the substrate, configured to supply power to the communications circuit.

13. The electronic device of claim 12, wherein the substrate comprises a bending region and a non-bending region,
the communications circuit is located on the non-bending region,
the battery is located on the non-bending region, and
the communications circuit and the battery are separated from each other by the bending region.

14. The electronic device of claim 13, further comprising another antenna disposed on the non-bending region,
wherein the communications circuit processes a first communications signal and a second communications signal,
the antenna transmits and/or receives the first communications signal, and
the other antenna transmits and/or receives the second communications signal.

15. The electronic device of claim 14, wherein the antenna comprises a conductor pattern,
the other antenna comprises a coil pattern, and
a frequency of the first communications signal is higher than a frequency of the second communications signal.

16. The electronic device of claim 13, wherein the communications circuit processes a communications signal.

17. The electronic device of claim 12, wherein the communications circuit wirelessly receives power and the battery is supplied with power by the communications circuit.

18. The electronic device of claim 10, wherein the first and/or second communications signals are used to control a vehicle.

19. The electronic device of claim 10, wherein the communications circuit generates and compresses a digital signal, converts the digital signal into an analog signal, and transmits the analog signal to the antenna.
